(19) United States
(12) Patent Application Publication
(10) Pub. No.: US 2008/0207237 A1
(43) Pub. Date: Aug. 28, 2008

(54) Communication in Phase Shifted Driven Power Converters

(75) Inventors: Wilhelmus Ettes, Drachten (NL); Andries Bron, Drachten (NL); Marnix Hegen, Hoogeveen (NL); Otto Welfing, Drachten (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/911,092

(22) PCT Filed: Apr. 6, 2006
(86) PCT No.: PCT/IB2006/051054

§ 371 Date: Oct. 9, 2007

(30) Foreign Application Priority Data
Apr. 14, 2005 (EP) 05102972.6
Apr. 6, 2006 (IB) PCT/IB2006/051054

(51) Int. Cl. H02M 3/158; H04Q 7/00; H04B 7/00

(52) U.S. Cl. 455/500

(57) ABSTRACT

A communication system comprises a plurality of communication modules (M1, . . . , MN) for phase shifted driving of a corresponding plurality of power converters (1, . . . , 3). The communication modules (M1, . . . , MN) are interconnected in a chain to exchange information for determining which communication module (M1, . . . , MN) is the first module (M1) in the chain, and for determining what the total number (N) of communication modules (M1, . . . , MN) in the chain is. Each communication module (M1, . . . , MN) comprises a controller (C1, . . . , CN) which controls, for all communication modules (M2, . . . , MN) except the first module (M1), a time of occurrence of an active phase of an associated one of the power converters (1, . . . , 3) in response to a synchronization signal (SI1, . . . , SIN−1) indicative for a time of occurrence of a previous active phase of a power converter (1, . . . , N−1) associated with the preceding communication module (M1, . . . , MN−1). The time difference (dT) of the active phase of a particular power converter (1, . . . , 3) with respect to the previous active phase is based on the total number (N) and on a duration (T) of the active phase.

### FIELD OF THE INVENTION

The invention relates to a communication system comprising a plurality of communication modules arranged in a chain for phase shifted driving of a corresponding plurality of power converters, a power converter system comprising such a communication system, an apparatus comprising such a power converter system, and a method of communicating in a system comprising phase shifted driven power converters.

### BACKGROUND OF THE INVENTION

U.S. Pat. No. 6,459,602 discloses a DC-to-DC power converter with improved transient response. Two or more converter circuits are incorporated in a multiphase-architecture to minimize the output voltage ripple and to reduce the recovery time. In a two-phase architecture, two reference signals are phase shifted by 180 degrees, in an N-phase architecture, the reference signals are phase shifted by 360/N degrees.

Although this multiphase architecture is able to generate the phase shifted drive signals for the N power supplies, this architecture is fixed for the particular number N, and thus provides a low flexibility in adapting the architecture to a particular application.

### SUMMARY OF THE INVENTION

It is an object of the invention to provide a system which is able to generate phase shifted drive signals for a multiphase power converter architecture and which has the flexibility to adapt to the actual number of power converters in the system.

A first aspect of the invention provides as claimed in claim 1. A second aspect of the invention provides a power converter system as claimed in claim 13. A third aspect of the invention provides an apparatus comprising the power converter system as claimed in claim 15. A fourth aspect of the invention provides a method of communicating in a communication system as claimed in claim 16. Advantageous embodiments are defined in the dependent claims.

In accordance with the first aspect of the invention, a communication system is provided which comprises a plurality of communication modules which drive a corresponding plurality of power converters with shifted active phases. These shifted active phases may partly overlap. The communication modules are interconnected in a chain for exchanging information to both determine which module is the first module in the chain, and what is the total number of modules in the chain. This is possible because the communication in the chain allows the modules to interact which each other and to exchange information. Each module comprises a controller which, for all modules except the first module, controls a time of occurrence of an active phase of the associated one of the power converters in response to a synchronization signal supplied by the preceding communication module. This synchronization signal is indicative for a time of occurrence of a previous active phase of a previous power converter associated with a preceding communication module in the chain. A time of occurrence of the present active phase of the present power converter associated with the present module is calculated by determining a time difference. This time difference with respect to the synchronization signal depends on the total number and on the duration of the active phase. The dependence on the total number allows selecting the most appropriate phase even if the number of modules differs in different applications.

Thus, each of the modules knows the total number of modules. And all modules except the first module have information about the time of occurrence of the previous active phase. The first module starts the first active phase or active time period with a desired duration which may depend on the output voltage of the power converter system. All other modules require a reference instant with respect to which the phase shift has to be made. This reference instant is indicated by the synchronization signal supplied by the preceding module. The synchronization signal may be the signal which defines the active phase of the preceding module. In particular, the starting edge of the signal may be used as the reference instant, but any other instant related to the phase of the preceding module may be used. The phase difference is created by determining a time delay with respect to the reference instant. This time delay is determined knowing the duration of the active period and the total number of modules present.

The chain of modules determines itself how many modules are present. Consequently, if the number of power converters and thus the associated communication modules is selected differently, the communication system automatically adapts the occurrence of the active phases of the associated power converters to the total number of power converters present in the system. A further advantage is that all the modules are completely identical. The different behavior of the first module is possible because the chain is able to find out which module is the first module.

In an embodiment as claimed in claim 2, each of the modules has a first and a second input/output port. The chain of modules is obtained by connecting the second input port of each module, which has a preceding module, to the first input port of the successive module. The identical modules are now interconnected and are able to transfer information between neighboring modules. If information has to be exchanged between not neighboring modules, this information has to ripple through the chain. Such a construction has the advantage that all the identical modules together are able to autonomously control the power converters. It is not required to have a central processor which requires having the flexibility to adapt the operation of the power converters such that the correct phase differences are obtained independent on the actual number of power converters used.

In an embodiment as claimed in claim 3, all modules supply a signal at their second port and check whether a signal is received at their first port. The module which does not receive a signal at its first port must be the first module in the chain. This module now knows that it is the first in the chain and has to act as the master, while all other modules know that they are not the first in the chain and should act as a slave. The ports of neighboring modules are preferably interconnected by a single wire. The signal on this wire may be just a predetermined level or may be a message in accordance with a communication protocol. For detecting which module is the first of the chain a level suffices, but of course a message may be used. Such a message may indicate that the information contained in the message is that this is the communication phase wherein the first module will be detected, such that the modules know that they have to ripple this information through the complete chain. However, because at the start of this procedure, it is not known which module is the first, all modules have to start this action autonomously. The best instant of starting this phase is directly after power on of the system.

In an embodiment as claimed in claim 4, the first module, which now knows that it is the first in the chain, provides a message to the next module in the chain indicating that the message originates from the first module in the chain. All other modules, which now know that they have to act as a slave, wait until they receive a message from the preceding module which indicates the position of the previous module in the chain. Preferably this message contains the number in the chain of the previous module. After the message has been received by a particular slave module, this module acknowledges the receipt of the message to the previous module. If a particular slave module after supplying the message at its second port does not receive an acknowledge signal, it is clear for this module that it is the last one in the chain. Because the modules keep track of the actual position in the chain and thus of the number of modules in the chain, the module which detected that it was the last in the chain knows the total number of modules in the chain.

In an embodiment as claimed in claim 5, the total number of modules in the chain is ripple through the complete chain from the last module to the first module. Now all modules know how many modules are actually present in the chain.

In an embodiment as claimed in claim 6, each one of the modules is constructed to use the total number to determine the phase difference between two adjacent modules. This phase difference is 90 degrees if the total number of communication modules in the chain is an even number, or 180 degrees divided by the total number if the total number of communication modules in the chain is an uneven number. Although all modules are identical, the first module knows that it is the first and thus starts with just generating its active period with a reference phase. All other modules know that they are slave modules and have to calculate the phase difference. This is an optimal solution for a single phase power rail application. In multiple mains phase applications other phase differences may provide minimal input ripple current.

In an embodiment as claimed in claim 7, each module provides a synchronization signal to the next module in the chain. This synchronization signal provides a reference instant which, together with the calculated phase difference is used by the next module to determine the time of occurrence of its active phase.

In an embodiment as claimed in claim 8, each module determines the time of occurrence of their active phase by first determining a time period between two successive synchronization signals and dividing this time period by the total number of modules in the chain to obtain the duration of an active phase. Now, each module knows the duration of the active phase and the phase difference to be made, and thus is able to calculate the time difference between the reference instant and the start of its active phase.

In an embodiment as claimed in claim 9, each module supplies a synchronization pulse which has the duration of the active phase of the associated power converter. Preferably, its timing coincides with the active phase. The slave modules can easily determine from the synchronization pulse what the duration of the active phase is.

In an embodiment as claimed in claim 10, the master module supplies a message on its second port indication what the duration of the active phase is. This message is rippled through the complete chain such that all modules know what the duration of the active phase is.

The indication of the duration of the active phase need not be the duration of the active phase. Any information from which the time shift required to obtain a particular phase difference can be used. For example the indication may indicate the time difference to be made to make a particular amount of phase shift.

In an embodiment as claimed in claim 11, the duration of the active phases of each of the power converters is identical. This simplifies the operation of the system because the different modules all determine the time shift of the active phase at the same manner. If different durations of active phases are used, the master module has to instruct the slave modules about the duration of their active phase. In fact this has three drawbacks. Firstly, every module should contain a memory which stores the different durations, or a program which determines the different durations, because all modules should be identical and only in the application it becomes clear which module is the first in the chain. Secondly, it becomes much more difficult to keep the power supplied by the power converters the same. And thirdly, the averaging effect of the phase shifted driving on the total input current of the power converters is disturbed.

In an embodiment as claimed in claim 12, the first and second input/output ports are single terminals such that the information is interchanged between adjacent modules over a single wire. The information may be a level or a message.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a prior art power converter system with two power converters,

FIGS. 2A to 2I show signals elucidating the operation of the prior art converter system shown in FIG. 1,

FIG. 3 shows a block diagram of a power converter system comprising an embodiment of a chain of communication modules in accordance with the invention,

FIG. 4 shows a flowchart elucidating the determination of the first module of the chain,

FIG. 5 shows a flowchart elucidating the chain number determination,

FIG. 6 shows a flowchart elucidating the determination of the total number, and

FIG. 7 shows a flowchart elucidating the determination of the phase in the communication modules.

### DETAILED DESCRIPTION

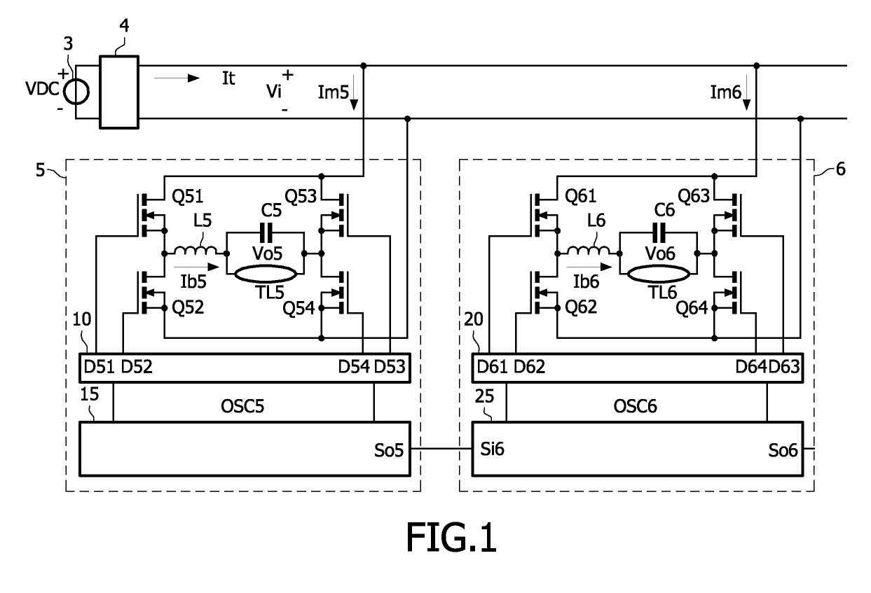

FIG. 1 shows a block diagram of a prior art power converter system with two power converters. Both the power converters are DC-DC converters based on a full bridge topology.

The power converter 5 comprises a parallel arrangement of two branches. One branch comprises a series arrangement of main current paths of a controllable switch Q51 and a controllable switch Q52, the other branch comprises a series arrangement of main current paths of a controllable switch Q53 and a controllable switch Q54. A full bridge driver 10 supplies drive signals D51, D52, D53, D54 to the control inputs of the controllable switches Q51, Q52, Q53, Q54, respectively. The two branches are arranged in parallel to receive a common DC-input voltage Vi. The load is arranged between the junctions of the series arranged switches. In the embodiment shown, the load is formed by a series arrangement of an inductor L5 with a parallel arrangement of a fluorescent lamp TL5 and a capacitor C5. The current through the load is indicated by Ib5.

The power converter 6 comprises a parallel arrangement of two branches. One branch comprises a series arrangement of main current paths of a controllable switch Q61 and a controllable switch Q62, the other branch comprises a series arrangement of main current paths of a controllable switch Q63 and a controllable switch Q64. A full bridge driver 20 supplies drive signals D61, D62, D63, D64 to the control inputs of the controllable switches Q61, Q62, Q63, Q64, respectively. The two branches are arranged in parallel to receive a common DC-input voltage Vi. The load is arranged between the junctions of the series arranged switches. In the embodiment shown, the load is formed by a series arrangement of an inductor L6 with a parallel arrangement of a fluorescent lamp TL6 and a capacitor C6. The current through the load is indicated by Ib6. However, the load may be any arbitrary load and need not be a lamp.

The power converter 5 draws a current Im5 from the DC-input voltage Vi, and the power converter 6 draws a current Im6 from the DC-input voltage Vi. The DC-input voltage Vi is the DC voltage VDC supplied by the source 3 minus the voltage drop across the differential mode noise filter 4 through which the current It flows which is the sum of the currents Im5 and Im6.

A master oscillator 15 supplies oscillator signals OSC5 to the full bridge driver 10 with a fixed phase such that de driver 10 is able to control the on and off-periods of the switches Q51, Q52, Q53, Q54. The master oscillator 15 further supplies a synchronization signal SO5 to the slave oscillator 25. The slave oscillator 25 supplies oscillator signals OSC6 to the full bridge driver 20 with a fixed phase such that de driver 20 is able to control the on and off-periods of the switches Q61, Q62, Q63, Q64. The synchronization signal S05 indicates the phase of the power converter 5 to the oscillator 25. The oscillator 25 performs a fixed phase shift such that the oscillator 25 generates its oscillator signals OSC6 with the correct phase shift with respect to the oscillator signals OSC5. Consequently the on and off-periods of the switches Q61, Q62, Q63, Q64 have the desired phase shift with respect to the on and off-periods of the switches Q51, Q52, Q53, Q54. Although commonly referred to as phase shift, in fact a time shift is meant because a phase shift is related to the duration of a total repetition period of the switch cycles of each of the power converters 5 and 6. The slave oscillator 25 has an output to supply a synchronization signal SO6 to a next power converter (not shown).

The power converter system shown and its driving is well know from the prior art and therefore not described in detail.

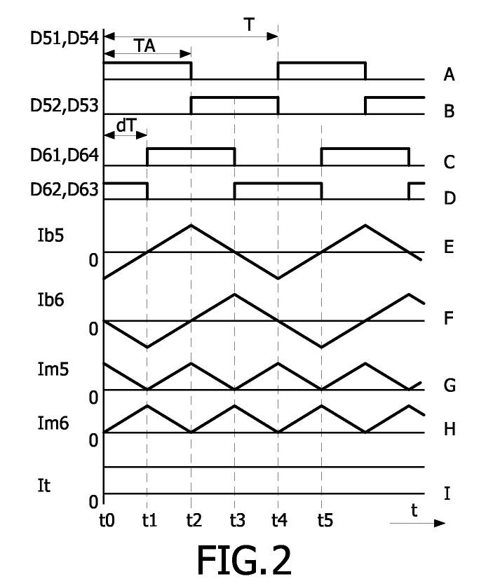

FIGS. 2A to 2I show signals elucidating the operation of the prior art converter system shown in FIG. 1.

FIG. 2A shows the on and off-periods of the switches D51 and D54. The on-period TA starts at t0 and ends at t2, the off-period starts at t2 and ends at t4. The cycle repeats itself starting at the instant t4. The repetition period T has a duration which is the sum of the durations of one on and off-period. This repetition period T is also referred to as the active period of the power converter. FIG. 2B shows the on- and off-periods of the switches D52 and D53. As is clear from FIGS. 2A and 2B, the on-periods of the switches D51 and D54 on the one hand and of the switches D52 and D53 on the other hand are non-overlapping. FIG. 2E shows the resulting current Ib5 through the load connected to the power converter 5, and FIG. 2G shows the current Im5 drawn by the power converter 5 from the input voltage Vi.

FIG. 2C shows the on and off-periods of the switches D61 and D64. The on-period starts at t1 and ends at t3, the off-period starts at t3 and ends at t5. The cycle repeats itself starting at the instant t5. FIG. 2D shows the on- and off-periods of the switches D62 and D63. As is clear from FIGS. 2C and 2D, the on-periods of the switches D61 and D64 on the one hand and of the switches D62 and D63 on the other hand are non-overlapping. FIG. 2F shows the resulting current Ib6 through the load connected to the power converter 6, and FIG. 2H shows the current Im6 drawn by the power converter 6 from the input voltage Vi.

FIG. 2I shows the total current It which is the sum of the currents Im5 and Im6. It becomes clear from FIGS. 2A to 2I that if the phase difference between the corresponding control signals for the corresponding switches of the two power converters 5 and 6 are phase shifted over 90 degrees, which is one quarter of the repetition period T and thus the time difference dT the current It has a constant level. Due to the minimized differential noise in the total current It, the differential noise filter 4 can now be much simpler.

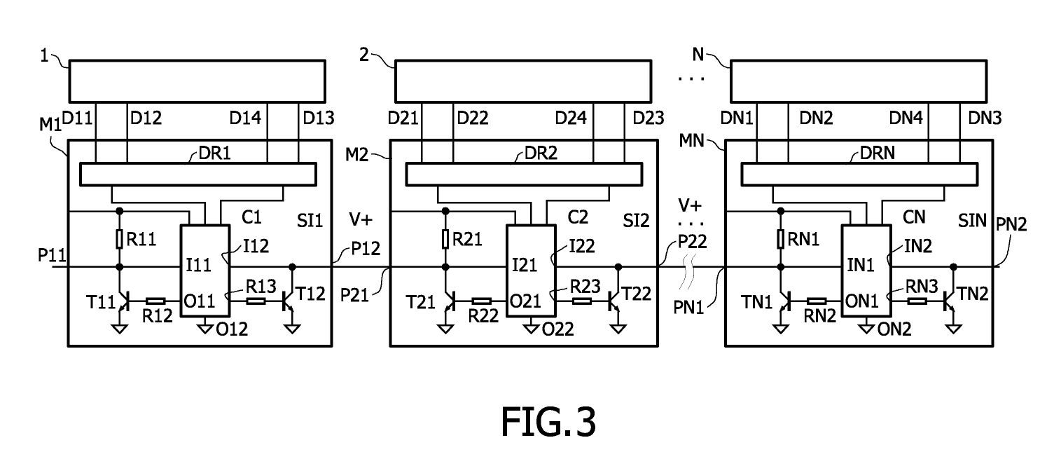

FIG. 3 shows a block diagram of a power converter system comprising an embodiment of a chain of communication modules in accordance with the invention. FIG. 3 shows 3 power converters 1, 2 and N of a system comprising N>1 power converters 1 to N.

It has to be noted that in FIG. 1 and FIGS. 2A to 2I, the power converters are defined to comprise the full bridge of switches, the full bridge drivers and the oscillators. However, in the now following the power converters 1 to N are defined to only comprise the full bridges of switches which receive the control signals for the control electrodes of the switches. The communication modules M1 to MN are defined to comprise the full bridge drivers DR1 to DRN, respectively and the controllers C1 to CN, respectively. However this is quite arbitral, the full bridge drivers DR1 to DRN may be part of the power supplies 1 to N instead of the communication modules M1 to MN.

All hardware elements, functional blocks, or signals in FIG. 3 which occur N times are indicated by at least one capital letter followed by an integer number, this number is an index indicating a particular one of the 1 to N occurrences. If the index is the letter i instead of a number in the range 1 to N, the item in general is meant, if the number is used the particular item is meant. Thus M1 indicates the first module in the chain, while Mi indicates one of the modules of the chain without being specific.

In the embodiment shown in FIG. 3, each one of the modules Mi comprise full bridge driver DRi which supplies the drive signals Di1, Di2, Di3, Di4 to the control inputs of the switches of the full bridge of the power converter i. A controller Ci controls the full bridge driver DRi. The controller I receives a power supply voltage V+. The input/output port Pi1 is connected to an input Ii1 of the controller Ci, and the input/output port Pi2 is connected to the input Ii2 of the controller Ci. The controller Ci has an output Oi1 which is connected via a resistor Ri2 to a base of a transistor Ti1. The transistor Ti1 has a collector connected to the input/output port Pi1, and an emitter connected to ground. A pull-up resistor Ri1 is connected between the input/output port Pi1 and the power supply voltage V+. The controller Ci further has an output Oi2 which is connected via a resistor Ri3 to a base of a transistor Ti2. The transistor Ti2 has a collector connected to the input output port Pi2 and an emitter connected to ground.

The controller Ci is able to both receive information and to supply information to both the input/output ports Pi1 and Pi2. Such an input/output ports Pi1, Pi2 which allow communication over a single wire are well known and can be realized on many other ways than shown in the embodiment of FIG. 3. Although preferred, it is however not essential to the invention that the communication must be performed by means of a single wire. For example, although a two wire bus requires an extra wire, the communication algorithm will become easier.

The input/output ports Pi2 of a particular module Mi are connected to the module Mi+1 which succeeds the particular module Mi in the chain. The input/output port P11 of the first module M1 and the input/output port PN2 of the last module MN are not connected to any other input/output port. In this manner, it is possible to directly exchange information between two adjacent modules Mi of which the input/output ports are interconnected. Information which should be exchanged between modules Mi which are not directly connected should ripple through the modules Mi in-between these modules Mi. The information may be the presence or absence of a signal, a particular level, or a coded message. The coded message may be transferred with a communication protocol allowing serial information transfer over a single wire.

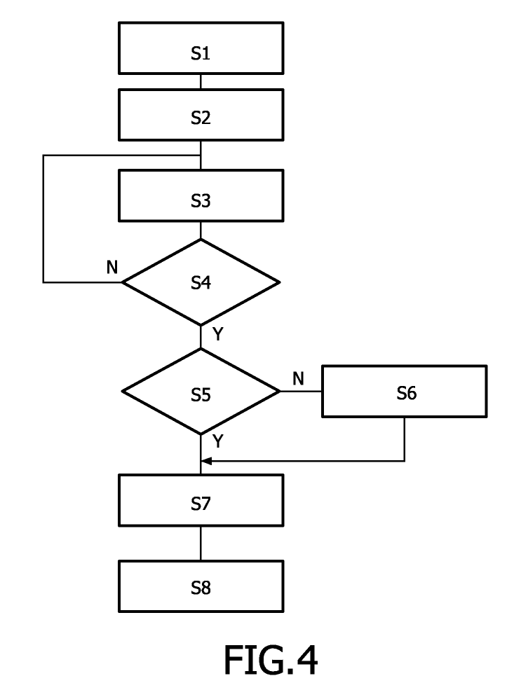

The operation of the power converter system shown in FIG. 3 will be elucidated with respect to the flowcharts shown in FIGS. 4 to 7.

FIG. 4 shows a flowchart elucidating the determination of the first module of the chain. Each of the modules Mi starts at step S1 to communicate with the other modules Mi in the chain to determine which module Mi is the first in the chain. This start of the process in step S1 may be triggered by a power switch on signal which is generated during switching on of the system. Each one of the modules Mi generates its own power switch on signal. The controller Ci of each module Mi receives the power switch on signal during the step S1 and knows that it should start the procedure for determination of the first module of the chain.

In step S2, all modules Mi activate their ports Pi2, for example by supplying a high level on these ports. Alternatively, a message of multiple bits may be sent. Then, in step S3, all modules check whether a signal is present at their ports Pi1. In step S4 is checked whether a predetermined period in time has been elapsed. If not, the module Mi repeats checking whether a signal is present at the port Pi1. If yes, in step S5, all modules Mi check whether during the predetermined period in time a signal was detected in the port Pi1. If a module Mi does not detect as signal, the port Pi1 is not connected to a port Pi2 and thus the module must be the first module M1 in the chain. In step S6, the first module M1 stores its number which is 1. If a module M1 detects a signal, the port Pi1 is connected to a port Pi2 and thus the module cannot be the first module M1 in the chain. In step S7, it is clear that the first module M1 has been identified, and all modules Mi deactivate their ports Pi2. In step S8 the process of finding the first module M1 in the chain is completed and all the modules Mi change to a state wherein the modules Mi proceed with determining the chain number of each one of the modules Mi.

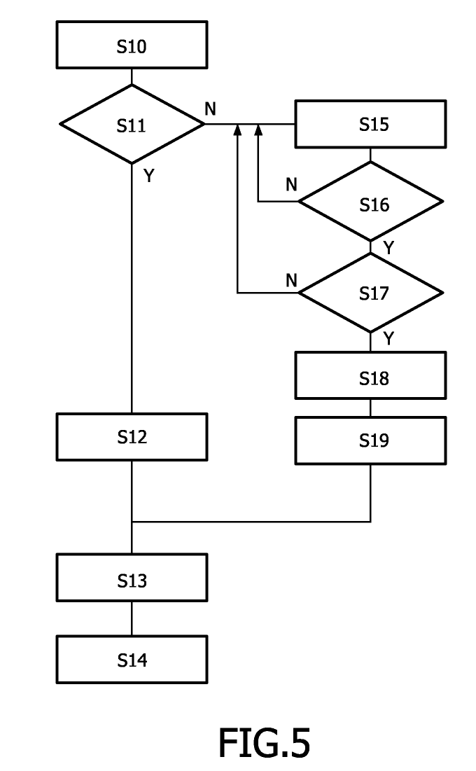

FIG. 5 shows a flowchart elucidating the chain number determination. In step S10 which is identical to step S8 of FIG. 4, the system of modules Mi knows which module Mi is the first in the chain and has to find out how many modules are in the system. In step S11, all the modules Mi check whether they are the first modules M1 in the chain. If yes, the first module M1 waits in step S12 during a predetermined time-out and modulates in step S13 its port P12 with an indication which module is sending the message. For example, the module M1 sends just the number 1 on its port M1. Alternatively, the module M1 may send a more complicated message which comprises a header and a number. The header indicates that the number following the header is the number of the module in the chain. In step S14, the module M1 ends its contribution to process of determination of the chain number.

If a module Mi detects in step S11 that it is not the first in the chain, it starts scanning its port Pi1 in step S15. All modules Mi except the first module M1 are collectively referred to as the other modules Mi. In step S16, all the other modules Mi check whether a start of a message is detected at their port Pi1. If not, the process returns to step S15. Thus all other modules Mi wait until a start of a message is detected. If a module Mi of the other modules Mi detects a start, this module Mi reads the message in step S17 until the end of the message is detected. When in step S17 the end of the message has been detected, the module proceeds with step S18 where the number received from the previous module Mi is increased by one. In step S19 the module Mi supplies an acknowledge on its port Pi1 to the previous module Mi in the chain. Then, the module Mi continues in step S13 with supplying its number determined in step S18 on its port Pi2 such that the next module Mi in the chain when performing its step S15 detects that the number of the previous module will be provided. In this manner, all the modules Mi acquire their position in the chain.

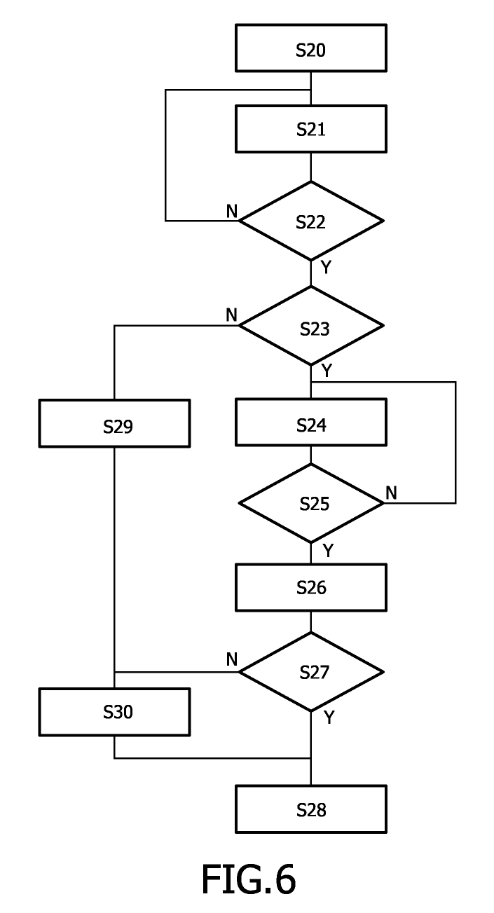

FIG. 6 shows a flowchart elucidating the determination of the total number. The third phase start in step S20, which is identical to step S14 of FIG. 5. Each other module Mi scans in step S21 its port Pi1 to check whether an acknowledge (step S19 of FIG. 5) is present. In step S22, it is checked whether a scan time out has elapsed, and if not, the process repeats the step S21. If yes, the process of the module Mi checks in step S23 whether an acknowledge was received during the scan time out.

If not, this module Mi must be last module MN in the chain. Now, in step S29, the number determined in step S18 of FIG. 5, of the last module MN is set to be the total number N of modules Mi in the chain. This total number N is supplied to the port PN1 of the last module MN in step S30, and the process of the last module MN ends the third phase in step S28. Again, the total number N may be part of a message with a header indicating that the message contains the total number N.

If yes, this module Mi cannot be the last module Mn in the chain. Now, in step S24 the module Mi is checking on its port Pi2 whether the total number message is present. In step S25, the module Mi checks whether the message is received, if not the process running on the controller Ci of the module Mi jumps back to the step S24. If yes, the module Mi takes over the total number N in step S26 and checks in step S27 whether its number is 1 which indicates that it is the first module M1 in the chain. If no, the process of the module Mi knows that there must be a preceding module Mi and thus puts in step S30 the total number N on its port Pi1. If in step S27 is detected that it is the first module M1 the third phase of the process in the module M1 is stopped at step S28, and the total number has rippled from the last module MN to the first module M1, through the complete chain of modules Mi. If in step S27 is detected that

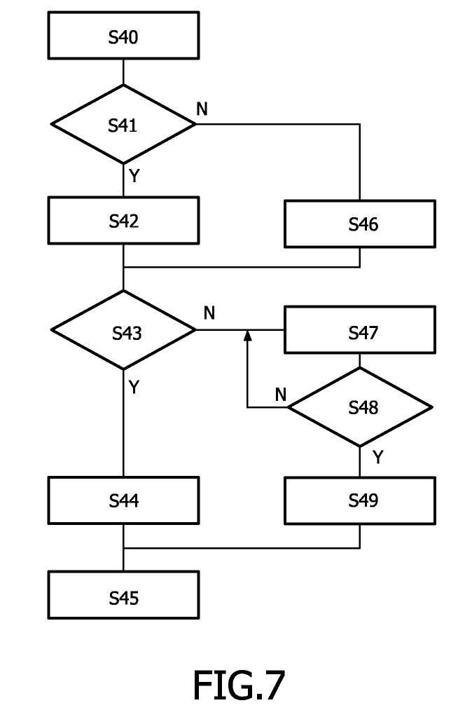

FIG. 7 shows a flowchart elucidating the determination of the phase in the communication modules. After phase 3, all modules Mi know the total number N of modules in the chain. In step S40 which is identical to step S28 in FIG. 6, phase 4 of the process of each one of the modules Mi starts. In step S41 is checked whether the total number N is even. If yes, in step 42, the phase difference is set to 90 degrees. The module Mi knows that it should start the active phase of the associated power converter i a quarter of a repetition period later than the active phase of the power converter i associated with the previous module M1 in the chain. If no, the phase difference is calculated to be 180 degrees divided by the total number N in step S46.

After the process running in each module Mi has set the phase difference to be obtained, the process proceeds in step S43 with checking whether the process is running on the first module M1. If yes, in step S44, the process of the module M1 provides control signals to the full bridge driver DR1 to control the active phase of the power converter 1. Thus the first module M1, which is the master module, starts the driving of the power converter chain by activating the first power converter 1.

Further, in step S44, the process of the module M1 modulates the port P12 with a synchronization signal which preferably is a pulse of which an edge is related to the active phase of the power converter 1. Preferably, the leading edge of the synchronization signal coincidents with the start of the active phase of the first power converter 1. For example, the synchronization signal may be the switching signal for two of the switches of the power converter 1, see for example FIG. 2A wherein the control signals D51, D54 have a leading edge at the instant t0. The phase difference or time delay dT (see FIG. 2C) of the next module in the chain is generated with respect to this leading edge.

In steps S47 to S49, the other modules Mi (not being the first module M1) generate the control signals for their associated power converter i with the phase shift determined in the steps S42 or S46. In step S47, the processes running in the other modules Mi scan their ports Pi1. If no synchronization pulse or message is detected in step S48, the process jumps back to the step S47. If a synchronization signal is detected in step S48, in step S49, the phase difference determined in step S42 or step S46 is used to generate the control signals for the full bridge driver DRi. Further, in step S49 a new synchronization signal is generated which indicates the active phase of the power converter i driven by the full bridge driver DRi. Now, the next module Mi in the chain is able to define the active phase of its associated power converter i again with respect to the synchronization signal supplied by the previous module Mi.

It has to be noted that all the modules Mi are identical, and that the controllers Ci of the modules Mi all perform the same processes. In a first phase it is determined which module Mi is the first module M1 of the chain. Now this first module M1 knows that it should act as the master, and the other modules Mi know that they should act as a slave. In a second phase the number of modules Mi in the chain is counted, in a third phase the total number N of modules Mi determined in the second step is rippled from the last module N in the chain to the first module M1 in the chain such that each module is aware of the total number N of modules in the chain, and thus is able to determine the optimal phase shift to be made. In a last phase, the first module M1 starts the operating phase by starting the active phase of the first power converter 1 and by providing a synchronization signal to the second module M2 in the chain. The second module M2 in the chain generates the active phase of the second power converter 2 with a phase difference or time difference dT with respect to the active phase of the first module M1. The phase difference dT was determined by using the total number N. The phase difference dT indicates how much time has to be lapsed from the instant indicated by the synchronization signal supplied by the first module M1 before the active period of the power converter 2 has to be started. The other modules Mi act in the same manner as the second module M2 and generate the active period of the associated power converter i with the phase difference determined in steps S42 or S46 in FIG. 7 with respect to the reference instant provided by the synchronization signal of the previous module Mi.

Preferably, the controllers Ci are microprocessors. Although the phase differences defined in steps S42 or S46 of FIG. 7 are optimal to minimize the ripple on the total current It (see FIG. 1), other phase differences may be predefined in the modules Mi.

The important issue is that all modules Mi are identical, are able to perform the same processes, but may perform slightly different processes after is known whether a module is the first module M1 or not. This makes the modules M1 completely interchangeable. Which is an advantage if one of the modules Mi is or becomes defective, this defective module Mi can easily be replaced by a standard module. Further, the system is very flexible, it does not matter how many modules Mi are present in the chain, the modules themselves find out how many modules are present and automatically adapt their active phases to this total number N. It is not required to use a central processing unit which checks the number of modules Mi used and which is able to communicate with all the modules Mi to set the phases of the modules Mi.

Although in the Figs. is shown that the power converters receive a same input voltage, the power converters and their associated communication modules may be used in multiple phase mains applications, such as for example a three phase mains application for driving three phase motors.

It should be noted that the above-mentioned embodiments illustrate rather than limit the invention, and that those skilled in the art will be able to design many alternative embodiments without departing from the scope of the appended claims. For example, the load of the power converters i is not relevant. Also the outputs of the power converters i may be interconnected to feed the output current to a common load.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A communication system comprising
a plurality of communication modules for phase shifted driving of a corresponding plurality of power converters, the communication modules being interconnected in a chain for exchanging information to determine which communication module is the first module in the chain, and what is a total number of communication modules in the chain, wherein each communication module comprises a controller for controlling, for all communication modules except the first module, a time of occurrence of an active phase of an associated one of the power converters in response to a synchronization signal indicative for a time of occurrence of a previous active phase of a power converter associated with the preceding communication module, and wherein a time difference of the active phase of a particular power converter with respect to the previous active phase is based on the total number and on a duration of the active phase.

2. A communication system as claimed in claim 1, wherein the communication modules have a first input/output port and a second input/output port, the second input/output port of a particular communication module being coupled to the first input/output port of the communication module preceding the particular communication module in the chain, and wherein the first input/output port of a first communication module (M1) in the chain is not connected to a second input/output port of another one of the communication modules, and the second input/output port of a last communication module in the chain is not connected to a first input/output port of another one of the communication modules.

3. A communication system as claimed in claim 2, wherein, during a start up phase, each one of the communication modules of the chain is constructed for supplying a predetermined signal at their second input/output port, and wherein the controllers are constructed for detecting whether an input signal is present at its first input/output port, and for concluding that it is the first communication module in the chain if no input signal is detected at its first input/output port.

4. A communication system as claimed in claim 3, wherein each controller is constructed:
for supplying an acknowledge signal on the first input/output port of the corresponding communication module after receiving an indication of a position of a preceding communication module in the chain at this first input/output port,
for supplying an indication indicating a position of the corresponding communication module in the chain via its second input/output port to the first input/output port of a next communication module in the chain, and
for checking whether an acknowledge has been received at its second input/output port to determine whether it is the last communication module in the chain and for generating a number indicating a total number of communication modules in the chain if no acknowledge has been detected.

5. A communication system as claimed in claim 4, wherein the controller of each communication module is constructed to provide a message to the previous communication module in the chain indicating the total number of communication modules in the chain to ripple the total number from the last communication module to the first communication module in the chain.

6. A communication system as claimed in claim 5, wherein the controller of each module is further constructed for determining the phase difference of two adjacent communication modules to be 90 degrees if the total number of communication modules in the chain is an even number, or 180 degrees divided by the total number if the total number of communication modules in the chain is an uneven number.

7. A communication system as claimed in claim 6, wherein the controller of each communication module is constructed for controlling the second input/output port to supply the synchronization signal to the first input/output port of a next communication module, wherein the synchronization signal is indicating a start of an active time period generated by the particular communication module.

8. A communication system as claimed in claim 7, wherein the controller of each communication module is constructed to determine the duration of the active phase by determining a time period between successive synchronization pulses and dividing this time period by the total number.

9. A communication system as claimed in claim 7, wherein the controller of each communication module is constructed for supplying the synchronization pulse having a duration equal to the duration of the active phase, and for determining the duration of the active phase by determining the duration of the synchronization pulse.

10. A communication system as claimed in claim 7, wherein the controller of each communication module is constructed for checking whether it is the first communication module and if is determined that it is the first communication module for supplying at its second input/output port an indication indicating a duration of the active phase, and if is determined that it is not the first communication module for rippling the indication through the chain of communication modules to enable each module to determine the time difference.

11. A communication system as claimed in claim 1, wherein the duration of the active phase is identical for each one the power converters.

12. A communication system as claimed in claim 2, wherein both the first input/output port and second input/output port are single terminals for interchanging the information between adjacent communication modules over a single wire.

13. A power converter system comprising
a plurality of power converters, and
a plurality of communication modules for phase shifted driving of the corresponding plurality of power converters.

14. A power converter system as claimed in claim 13, wherein power converter inputs of the power converters are arranged to receive a common DC-input voltage.

15. An apparatus comprising the power converter system as claimed in claim 13, and circuits for drawing current from DC-output voltages supplied by the power converters.

16. A method of communicating in a communication system comprising a plurality of communication modules for phase shifted driving of a corresponding plurality of power converters, wherein the communication modules are interconnected in a chain, the method comprising
exchanging information between the communication modules to determine which communication module is the first module in the chain, and what is a total number (N) of communication modules in the chain,
for each communication module, generating a synchronization signal indicative for a time of occurrence of an active phase of a power converter associated with the communication module,
controlling, for all communication modules except the first communication module, a time of occurrence of an active phase of an associated one of the power converters in response to a synchronization signal received from a preceding communication module, wherein a phase difference with respect to the previous active phase is based on the total number and on a duration of the active phase.
